(19) United States
(12) Patent Application Publication
(10) Pub. No.: US 2025/0147170 A1
(43) Pub. Date: May 8, 2025

(54) METHOD FOR DERIVING POSITION DURING NAVIGATION

(71) Applicant: BlueSpace.ai, Inc., Santa Clara, CA (US)

(72) Inventors: Joel Pazhayampallil, Oakland, CA (US); Jeremy Alan Templeton, Castro Valley, CA (US)

(21) Appl. No.: 18/940,481

(22) Filed: Nov. 7, 2024

Related U.S. Application Data
(60) Provisional application No. 63/547,607, filed on Nov. 7, 2023.

(51) Int. Cl. G01S 13/60; G01S 13/89; G01S 13/931

(52) U.S. Cl. CPC G01S 13/60; G01S 13/89; G01S 13/931; G01S 2013/9323

(57) ABSTRACT

One variation of a method includes: accessing an image generated by a sensor arranged on a vehicle, the image including a set of points representing positions and radial velocities of surfaces in a field of view of the sensor during a scan cycle; detecting a constellation of points, in the set of points in the image, representing a static surface in the field of view of the sensor; calculating a linear velocity of the vehicle relative to the static surface during the scan cycle based on radial velocities of the constellation of points; accessing an angular velocity of the vehicle during the scan cycle detected by a motion sensor arranged on the vehicle; and calculating a change in position of the vehicle during the scan cycle based on the linear velocity, the angular velocity, and a duration of the scan cycle.

### CROSS-REFERENCE TO RELATED APPLICATIONS

This application claims the benefit of U.S. Provisional Application No. 63/547,607, filed on 7 Nov. 2023, which is incorporated in its entirety by this reference.

This application is related to U.S. patent application Ser. No. 17/182,165, filed on 22 Feb. 2021, which is incorporated in its entirety by this reference.

### TECHNICAL FIELD

This invention relates generally to the field of navigation systems and more specifically to a new and useful method for deriving a change in position of a vehicle during navigation within the field of navigation systems.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method; and

FIG. 4 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

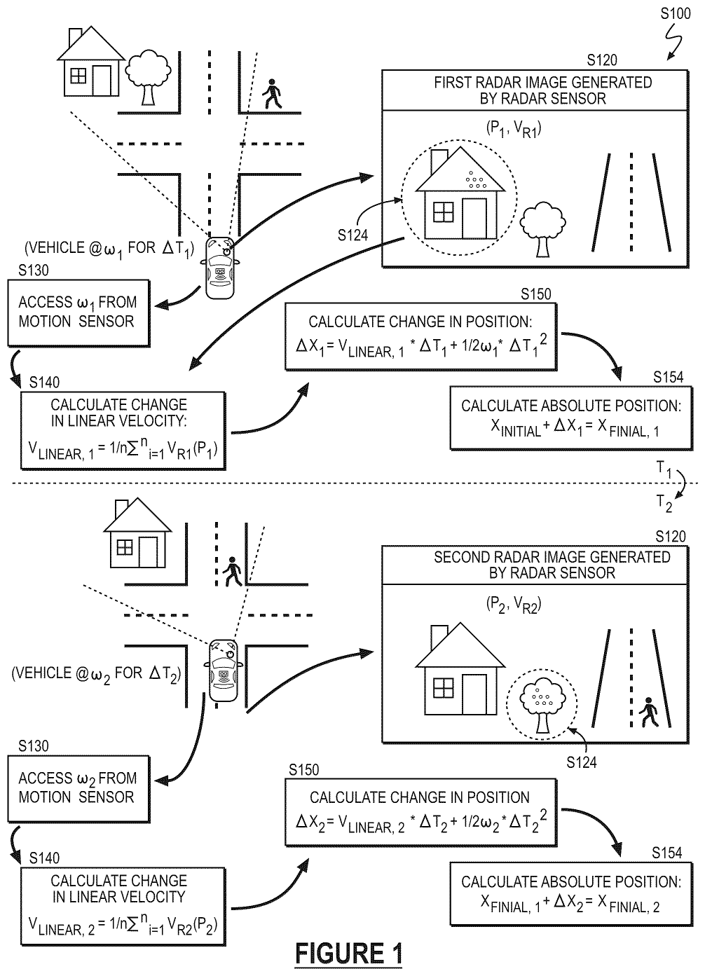

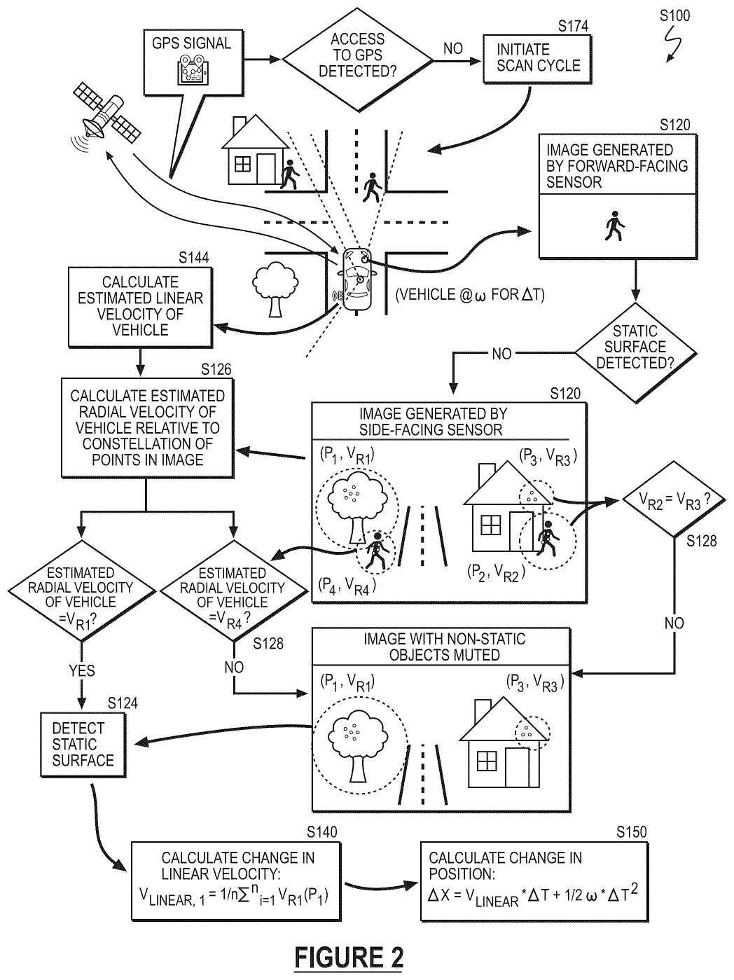

As shown in FIGS. 1 and 2, a method S100 includes accessing a radar image generated by a radar sensor arranged on a vehicle, the radar image including a set of points: representing positions of a set of surfaces in a field of view of the radar sensor during a scan cycle; and annotated with radial velocities of the set of surfaces relative to the radar sensor in Block S120.

The method S100 also includes: detecting a constellation of points, in the set of points in the radar image, representing a static surface in the set of surfaces in Block S124; calculating a linear velocity of the vehicle relative to the static surface during the scan cycle based on radial velocities of the constellation of points in Block S140; accessing an angular velocity of the vehicle during the scan cycle detected by a motion sensor arranged on the vehicle in Block S130; and calculating a change in position of the vehicle during the scan cycle based on the linear velocity, the angular velocity, and a duration of the scan cycle in Block S150.

### 1.1 Variation: Electromagnetic Sensors

As shown in FIGS. 1 and 2, one variation of the method S100 includes accessing an image generated by an electromagnetic sensor arranged on a vehicle, the image including a set of points: representing positions of a set of surfaces in a field of view of the electromagnetic sensor during a scan cycle; and annotated with radial velocities of the set of surfaces relative to the electromagnetic sensor in Block S120.

This variation of the method S100 also includes: detecting a constellation of points, in the set of points in the image, representing a static surface in the set of surfaces in Block S124; calculating a linear velocity of the vehicle relative to the static surface during the scan cycle based on radial velocities of the constellation of points in Block S140; accessing an angular velocity of the vehicle during the scan cycle detected by a motion sensor arranged on the vehicle in Block S130; and calculating a change in position of the vehicle during the scan cycle based on the linear velocity, the angular velocity, and a duration of the scan cycle in Block S150.

### 1.2 Variation: Navigational Actions

As shown in FIGS. 1, 3, and 4, one variation of the method S100 includes accessing an image generated by an electromagnetic sensor arranged on a vehicle, the image including a set of points: representing positions of a set of surfaces in a field of view of the electromagnetic sensor during a scan cycle; and annotated with radial velocities of the set of surfaces relative to the electromagnetic sensor in Block S120.

This variation of the method S100 also includes: detecting a constellation of points, in the set of points in the image, representing a static surface in the set of surfaces in Block S124; calculating a linear velocity of the vehicle relative to the static surface during the scan cycle based on radial velocities of the constellation of points in Block S140; accessing an angular velocity of the vehicle during the scan cycle in Block S130; and calculating a change in position of the vehicle during the scan cycle based on the linear velocity, the angular velocity, and a duration of the scan cycle in Block S150. The method S100 further includes electing a navigational action based on the change in position of the vehicle in Block S198.

### 2. Applications

Generally, a vehicle (e.g., an autonomous vehicle) can execute Blocks of the method S100: to access a radar image (or “an image”) generated by a radar sensor arranged on the vehicle, the image depicting an environment (e.g., surfaces, objects)—within a field of view of the radar sensor—surrounding the vehicle during a scan cycle; to detect a constellation of points in the image representing a static surface in the environment; and to derive motion of the vehicle relative to the static surface during the scan cycle based on motion of the constellation of points—representing the static surface—depicted in the image.

In particular, each point in the constellation of points representing the static surface is annotated with movement data (e.g., a position, a radial velocity) relative to the radar sensor. The static surface is “fixed” in the environment and therefore, the movement (e.g., radial velocity) of the constellation of points—representing the static surface in the image—can be equivalent to the movement of vehicle.

Accordingly, to derive motion of the vehicle during the scan cycle, the vehicle can: calculate a linear velocity of the vehicle relative to the static surface based on movement data represented in the constellation of points; and calculate a change in position of the vehicle during the scan cycle based on the linear velocity, the angular velocity of the vehicle during the scan cycle (e.g., detected by a motion sensor), and a duration of the scan cycle.

Generally, for each scan cycle, the vehicle can: calculate a change in position during the scan cycle based on movement data represented in the image generated by the radar sensor for the scan cycle; access an initial position of the vehicle proximal a start of the scan cycle; and derive a final position of the vehicle proximal an end of the scan cycle based on the change in position from the initial position. The vehicle can then elect a navigational action (e.g., brake, turn) based on the final position of the vehicle proximal an end of the scan cycle.

Accordingly, the vehicle can fuse relative movement of static surfaces—derived from real-time radar images—with the angular velocity of the vehicle to calculate and track the position of the vehicle while in motion. The vehicle can thus reduce reliance on inertial measurement units (IMUs)—prone to accumulating errors in dead reckoning-based position calculations—to improve odometry accuracy. More specifically, an IMU (e.g., an accelerometer) can introduce errors to the position calculation when integrating the acceleration data detected by the IMU to calculate position. In particular, small errors in the acceleration data compound through both integration steps (i.e., first integrating acceleration data to obtain velocity and then integrating velocity to estimate position), leading to significant position drift over time. Therefore, the vehicle can increase accuracy and reliability of its calculated changes in position (or “dead reckoning”): leveraging relative movement of static surfaces in the environment surrounding the vehicle, as represented in radar images captured by a radar sensor on the vehicle, to derive an absolute, directly-measured velocity of the vehicle during a scan cycle; dead-reckon a change in the vehicle's position during this scan cycle by integrating this absolute, directly-measured velocity once rather than double-integrating a noisy acceleration signal output by an accelerometer (or inertia measurement unit, etc.) in the vehicle; repeat this process during each subsequent scan cycle to accumulate total change in position of the vehicle over time; and thus reduce cumulative positional error (or “drift”) resulting from dead reckoning techniques reliant on integrating acceleration signals for estimated velocities.

### 2.1 Selective Illumination

In one application, the vehicle executes Blocks of the method S100: to identify a position of a target entity (e.g., another vehicle, a structure, an installation) relative to a radar sensor arranged on the vehicle; to calculate an active region—divergent from the position of the target entity—of the field of view of the radar sensor; and to calculate an inactive region, coincident the position of the target entity, of the field of view of the radar sensor. Then, the vehicle can execute Blocks of the method S100: to selectively transmit signals—via the radar sensor—within the active region of the field of view of the radar sensor while selectively disabling signal transmission of the inactive region of the field of view of the radar sensor.

Accordingly, by selectively transmitting signals within the active region of the field of view—while selectively disabling signal transmission within the inactive region of the field of view—the vehicle can: increase resolution of a resultant image by consolidating bandwidth (e.g., points per second) of the radar sensor to the active region of the field of view; and/or reduce power consumption of the radar sensor.

Additionally, for a target entity by which the vehicle avoids detection (e.g., an adversary defense installation), the vehicle can execute Blocks of the method S100 to constrain signal transmission by the radar sensor within the active region of the field of view—diverging from the target entity—thereby reducing an electromagnetic signature of the vehicle and minimizing a probability of detection by the target entity based on signal transmission by the radar sensor.

Furthermore, the vehicle can execute Blocks of the method S100 to further constrain signal transmission, by the radar sensor, to a second target entity by which the vehicle seeks detection (e.g., an aircraft carrier on which the vehicle is landing). Therefore, the vehicle can maximize an electromagnetic signature of the vehicle detectable by the target entity while minimizing a probability of detection—by other entities by which the vehicle avoids detection—based on signal transmission by the radar sensor.

### 2.2 Example: Reconnaissance Vehicle

In one example application, a reconnaissance vehicle (hereinafter the “recon vehicle”) is deployed from a starting position in an operating field and navigates northbound toward a suspected enemy weapon installation (hereinafter the “target installation”) to capture intelligence. The recon vehicle: identifies the position of a target installation relative to a radar sensor arranged on the recon vehicle; and defines the position of the target installation at a 0° rotational position relative to the radar sensor.

In this example application, the recon vehicle calculates an active region—divergent from the position of the target installation (e.g., in a southern direction)—of a field of view of the radar sensor, the active region spanning from a 45° rotational position relative to the radar sensor to a 315° rotational position relative to the radar sensor. The recon vehicle also calculates an inactive region—coincident the position of the target installation (e.g., in a northern direction)—of the field of view of the radar sensor, the inactive region spanning from the 315° rotational position relative to the radar sensor to the 45° rotational position relative to the radar sensor. Then, the recon vehicle selectively transmits signals—via the radar sensor—within the active region of the field of view of the radar sensor while selectively disabling signal transmission within the inactive region of the field of view.

The recon vehicle then maps the environment surrounding the vehicle by measuring point clouds representing positions and strengths of returned radar signals and associating these point clouds across scans. In particular, the radar sensor generates a radar image (or an “image”) representing relative positions and radial velocities of the surfaces and/or objects in the field of view of the radar sensor.

Additionally, the recon vehicle: detects objects within the active region of the field of view of the radar sensor (e.g., static objects located south of the recon vehicle); derives motion of the recon vehicle from these objects; and elects navigation actions based on this motion.

Accordingly, the recon vehicle selectively scans an environment surrounding the recon vehicle to execute navigation and state estimation tasks while minimizing a probability of detection by the target installation based on signal transmission by the radar sensor.

### 2.3 Mobile Platform+Electromagnetic Sensors

The method S100 is described herein as executed by a vehicle in conjunction with radio detection and ranging (or “radar”) sensors to calculate changes in position and/or to track absolute position of the vehicle (e.g., “dead reckoning”). Alternatively, the vehicle can execute Blocks of the method S100 in conjunction with a light detection and ranging (or “lidar”) sensor (e.g., a spinning lidar sensor, a fixed lidar sensor) to calculate changes in position and/or to track absolute position of the vehicle.

However, the method S100 can be executed by any other mobile platform (e.g., a robotic system, drone, autonomous vehicle) or any other object (e.g., a backpack worn by a user, survey equipment) in conjunction with a radar, lidar, or other electromagnetic sensor to calculate changes in position and/or to track absolute position of the platform.

Additionally or alternatively, the method S100 can be executed by a computer system—in conjunction with or including an electromagnetic sensor—to calculate changes in position and/or to track absolute position of the computer system. for example, the computer system and the electromagnetic sensor can be located on or integrated into a backpack, surveying equipment, shipping containers, cargo pallets, communication relays and field antennas, weather monitoring equipment, or scientific research kits, etc.

### 3. Vehicle

The vehicle can include: a suite of sensors configured to collect data representative of objects in the environment surrounding the vehicle; local memory that stores a navigation map defining a route for execution by the vehicle, and a localization map that represents locations of immutable surfaces along a roadway; and a controller. The controller can: calculate the location of the vehicle in real space based on sensor data collected from the suite of sensors and the localization map; calculate future state boundaries of objects detected in these sensor data; elect future navigational actions based on these future state boundaries, the real location of the vehicle, and the navigation map; and control actuators within the vehicle (e.g., accelerator, brake, and steering actuators) according to these navigation decisions.

### 3.1 Radar Sensors

In one implementation, the vehicle includes a set of radar sensors arranged on the vehicle and configured to detect presence and speeds of objects near the vehicle. For example, the vehicle can include a set of (i.e., one or more) radar sensors, such as one radar sensor arranged at the front of the vehicle and a second radar sensor arranged at the rear of the vehicle, or a cluster of radar sensors arranged on the roof of the vehicle. Each radar sensor can generate (or “output”) one image (e.g., a three-dimensional distance map, a three-dimensional point cloud, a four-dimensional point cloud) per scan cycle executed by the radar sensor, the image depicting surfaces and/or objects in the field of view of the radar sensor during the scan cycle.

In one implementation, the vehicle includes a radar sensor configured to: transmit a signal (e.g., radio frequency signals) via an emitter; and receive the signal via an array of antennas.

In another implementation, the vehicle includes a radar sensor configured to generate an image containing a set of points: representing relative positions of a set of surfaces in the field of view of the radar sensor during the scan cycle; and annotated with speeds (i.e., radial velocities) of the set of surfaces along a ray extending from the radar sensor (or the vehicle more generally) to this surface.

### 3.2 Motion Sensors

In another implementation, the vehicle includes a motion sensor, such as an inertial measurement unit (or “IMU”) including a three-axis accelerometer and a three-axis gyroscope. During operation of the vehicle, the vehicle can sample motion data from the motion sensor and interpret motion of the vehicle based on these motion data, such as including average angular pitch, yaw, and roll velocities.

However, the vehicle can include any other sensors and can implement any other scanning, signal processing, and autonomous navigation techniques or models to calculate the geospatial position and orientation of the vehicle, to perceive objects in its vicinity, and to elect navigational actions based on sensor data collected through these sensors.

### 4. Scan Cycle

Generally, the vehicle can execute the scan cycle to calculate the geospatial position of the vehicle when the vehicle is in motion, such as in response to detection motion of the vehicle and/or in response to loss of access to a geospatial positioning system. More specifically, the vehicle can trigger execution of the scan cycle (e.g., via the controller): to calculate a velocity of the vehicle relative to the static surfaces in the environment surrounding the vehicle; and to derive a change in position of the vehicle during the scan cycle.

In one implementation, as shown in FIG. 1, the vehicle can: access an image (e.g., generated by an electromagnetic sensor) including a set of points representing positions and radial velocities of surfaces in an environment surrounding the vehicle during the scan cycle; and detect a constellation of points in the image representing a static surface in the environment. The static surface(s) can be considered “fixed” in the environment. Thus, the movement (e.g., radial velocity) of the static surface(s)—depicted in the image—can be equivalent to the movement of the vehicle. Accordingly, the vehicle can calculate a linear velocity of the vehicle relative to the static surface during the scan cycle based on radial velocities of the constellation of points. In particular, the vehicle can decompose radial velocities of the static points into linear components along the direction of motion of the vehicle. These linear components collectively represent the overall velocity of the vehicle relative to the static surface. The vehicle can then calculate a change in position of the vehicle during the scan cycle based on the linear velocity, the angular velocity of the vehicle during the scan cycle (e.g., detected by a motion sensor), and a duration of the scan cycle.

Accordingly, the system can: initiate the scan cycle to capture an image of the environment surrounding the vehicle; detect a static surface—represented by a constellation of points in the image—proximal the vehicle during the scan cycle; and calculate a change in position of the vehicle during the scan cycle based on movement of the static surface—represented in the constellation of points—relative to the vehicle.

Accordingly, the vehicle can improve the accuracy of the position calculation by reducing reliance on inertial measurement units (IMUs), which are prone to accumulating errors in dead reckoning-based position calculations. More specifically, IMUs can introduce errors during the double integration process required to calculate position from acceleration data (i.e., first integrating acceleration data to obtain velocity and then integrating velocity to estimate position). Furthermore, small errors in acceleration data compound through both integration steps, leading to significant position drift over time. Therefore, the vehicle can leverage static surfaces in the environment to calculate movement relative to these surfaces, thereby avoiding the drift associated with IMU-based double integration, thereby resulting in more accurate and reliable position tracking.

### 4.1 Scan Cycle Initiation

Generally, the vehicle can implement radar sensor(s) in conjunction with dead reckoning-based methods and techniques described above and/or implement a geospatial positioning system (or “GPS”) arranged within the vehicle to calculate the absolute geospatial position (or “position”) of the vehicle during motion.

In one implementation, the vehicle executes Blocks of the method S100 separately and concurrently with geospatial positioning monitoring via the GPS, such as to generate a redundant or secondary geospatial position estimate of the vehicle in addition to a primary geospatial position derived from the GPS. In this implementation, the vehicle can: default to reliance on the primary GPS-derived geospatial position for its geospatial position record or navigational decisions, etc.; implement methods and techniques described below to characterize accuracy of or confidence in the primary GPS-derived geospatial position; and then transition to reliance on the secondary geospatial position—derived according to the method S100—for its geospatial position record or navigational decisions, etc.

Alternatively, the vehicle can exclude a GPS sensor altogether and can exclusively execute Blocks of the method S100 to track changes in its position, such as relative to a starting position.

### 4.1.1 GPS-Denied Scan Cycle Initiation

One variation of the method S100 includes Block S174, which recites initiating the scan cycle in response to loss of access to a geospatial positioning system. In one implementation, in Block S174, in response to detecting loss of GPS access, the vehicle can initiate the scan cycle to calculate the change in position of the vehicle during the scan cycle via dead reckoning based on data detected by the radar sensor(s), as shown in FIG. 2.

In another implementation, the vehicle can initiate the scan cycle—to calculate changes in position and/or track geospatial positions of the vehicle via ambient surface velocities represented in radar images—in response to detecting a GPS error (i.e., an error in the position calculated by GPS) exceeding a threshold error value. For example, the vehicle can: initiate a scan cycle to capture an image—via a radar sensor—depicting the environment surrounding the vehicle during the scan cycle; implement methods and techniques described above to calculate a radar-based position of the vehicle via dead reckoning and based on movement data detected by the radar sensor and depicted in the image; and calculate a GPS-based position of the vehicle via a GPS arranged within the vehicle. In particular, in this example, the vehicle can calculate a GPS error based on a difference between the radar-based position and the GPS-based position of the vehicle. The vehicle can then, in response to the GPS error exceeding a threshold error value: deactivate the GPS; activate the radar sensor(s); and implement dead reckoning-based methods and techniques described above to calculate the position of the vehicle during successive scan cycles.

Additionally or alternatively, in response to detecting absence of a linear velocity of the vehicle (i.e., representing that vehicle is stationary), the vehicle can initiate a scan cycle: to trigger the GPS to transmit a series of signals to a satellite associated with the GPS; calculate a time series of GPS-based positions of the vehicle based on signals returned by the satellite; and to calculate a GPS error based on a variance in the time series of GPS-based positions (e.g., the variance in the GPS signal over time). The vehicle can then, in response to the GPS error exceeding a threshold error value: deactivate the GPS; activate the radar sensor(s); and implement dead reckoning-based methods and techniques described above to calculate the position of the vehicle during successive scan cycles.

In another implementation, the vehicle can initiate the scan cycle in response to detecting a position of the vehicle within a target geospatial zone, such as a geospatial zone associated with high GPS error. In one example, the vehicle can initiate a scan cycle in response to detecting a geospatial position of the vehicle—calculated via GPS—within a city center (e.g., a zone densely populated with buildings that obstruct radio frequency signals and create multipath effects that degrade GPS accuracy).

In another example, the vehicle can initiate a scan cycle in response to detecting a geospatial position of the vehicle—calculated via GPS—within a suspected enemy zone (e.g., a zone associated with risk of GPS signal jamming and/or detection by an enemy).

Accordingly, the vehicle can initiate a scan cycle to calculate the position of the vehicle via dead reckoning: in conjunction with GPS, such as in response to detecting a position of the vehicle within a geospatial zone associated with low GPS error (i.e., to supplement the GPS-based position calculated by the GPS); or as an alternative to GPS, such as in response to loss of GPS access, detecting a position of the vehicle within a geospatial zone associated with high GPS error, and/or detecting a position of the vehicle within a geospatial zone associated with risk of GPS signal jamming. Therefore, the vehicle ensures continuous and reliable positioning by leveraging dead reckoning methods and radar sensor(s), independent of access and/or accuracy of the GPS, to supplement positioning. Thus, the vehicle can accurately calculate the position of the vehicle in a diverse range of environments (e.g., GPS-denied zones).

### 5. Image Ingest

Block S120 of the method S100 recites accessing an image generated by a radar sensor arranged on a vehicle, the image including a set of points: representing positions of a set of surfaces in a field of view of the radar sensor during a scan cycle; and annotated with radial velocities of the set of surfaces relative to the radar sensor. Generally, in Block S120, the vehicle can access an image generated by the radar sensor and containing a set of points annotated (or “labeled”) with radial velocities (e.g., Doppler shifts), radial positions, and azimuthal positions of the set of surfaces relative to the radar sensor.

### 6. Static Surface Detection

Block S124 of the method S100 recites detecting a constellation of points, in the set of points in the image, representing a static surface in the set of surfaces. Generally, in Block S124 the vehicle can group points in the image into constellations (or “clusters”) of points that exhibit congruent motion, such as described in U.S. patent application Ser. No. 17/182,165.

In one implementation, for a first scan cycle, the vehicle can access a radar image (or “an image”) generated by a radar sensor and including a set of points representing surfaces and/or objects in the field of view of the radar sensor. In particular, the vehicle can access the image annotated with positions and radial velocities of a set of surfaces relative to the radar sensor. The vehicle can then: aggregate (or isolate) a constellation of points—in the set of points—clustered at similar depths from the vehicle and labeled with speeds (e.g., range rates, azimuthal speeds) that are self-consistent (e.g., exhibiting congruent motion) for a contiguous, static surface; and associate this constellation of points with a static surface in the environment. In particular, the vehicle can isolate a constellation of points characterized by absolute angular and linear velocities of approximately null (i.e., exhibiting absolute motion of ‘null’).

For example, the vehicle can isolate a first constellation of points—in the set of points—that: approximate a planar surface represented by a normal vector nonparallel to the axis of rotation of the radar sensor; fall within a threshold distance of the vehicle (e.g., between two meters and ten meters from the first optical sensor); and intersect a known ground plane within the image. The vehicle can then label this first constellation of points as representing a static surface.

In one variation, the vehicle can repeat the forgoing process: to detect and label each static surface represented in the image; and to compile a composite constellation of points—in the set of points in the image—representing a set of static surfaces. The vehicle can then implement the method S100 and techniques described above to calculate a change in position of the vehicle during the scan cycle based on movement of the set of static surfaces—represented in the composite constellation of points—relative to the vehicle.

Alternatively, in the preceding variation, the vehicle can select a first static surface from this set of static surfaces, such as a largest static surface in the set; a largest static surface nearest a target distance from the radar sensor (e.g., nearest a nominal operating distance of the radar sensor, such as ten meters); a static surface represented by more than a minimum quantity of points in the image and nearest a ground plane (e.g., a planar road surface); and/or a static surface identified as a target static object (e.g., a building, a tree) by a perception model executed by the vehicle.

The vehicle can then implement the method S100 and techniques described above: to isolate a first constellation of points—in the composite constellation of points in the image—representing the first static surface; and to calculate the change in position of the vehicle during the scan cycle based on movement of the first static surface—represented in the first constellation of points—relative to the vehicle. Thus, the vehicle can accurately calculate a change in position by leveraging movement data of static surfaces in the field of view of the radar sensor to derive relative movement of the vehicle, thereby ensuring reliable position tracking without reliance on GPS.

### 7. Non-Static Object Detection+Muting

In one implementation, following access (or capture) of an image for a current scan cycle, the vehicle executes object detection techniques: to associate clusters of points in the image with non-static surfaces and/or objects in the environment around the autonomous vehicle; and to mute these non-static objects from the image when identifying a static surface(s).

For example, the vehicle can: detect (or “isolate”) a constellation of points clustered at similar depths from the vehicle that are annotated with speeds (e.g., range rates, azimuthal speeds) that are self-consistent (e.g., exhibiting congruent motion) for a contiguous object; and associate this constellation of points with a non-static object in the field.

Thus, the vehicle can filter out (or “eliminate”) non-static objects—represented in the set of points in the image—in the surrounding environment that introduce noise (i.e., discrepancies) in the positioning calculation, thereby preventing misinterpretation of motion of dynamic objects as part of the movement of the vehicle and/or the position of static surfaces.

### 7.1 Variation: Non-Static Object Detection Based on Adjacent Points

In one variation, as shown in FIG. 2, the vehicle can detect non-static objects by: detecting a first constellation of points, in the set of points in the image, annotated with a first radial velocity relative to the radar sensor in Block S126; detecting a second constellation of points, in the set of points in the image, adjacent the first constellation of points and annotated with radial velocities relative to the radar sensor in Block S126; and, in response to detecting the second constellation of points annotated with the radial velocities, different from the first radial velocity, identifying the first constellation of points as a non-static surface in Block S128. In this variation, in Block S128, the vehicle can mute the first constellation of points in the image in response to detecting the non-static surface. The vehicle can repeat the foregoing process to mute each non-static object detected in the image. Thus, the vehicle can dynamically filter out non-static objects—such as moving vehicles or pedestrians—by leveraging differences in radial velocities between constellations of points in the image. By detecting varying speeds between adjacent points, the vehicle can accurately distinguish between static surfaces and dynamic objects, removing the latter to enable the vehicle to focus on reliable, stationary references for position calculations.

### 7.2 Variation: Non-Static Object Tracking+Confidence Score

In one variation, as shown in FIG. 2, the vehicle can detect and track non-static objects by: detecting a first constellation of points exhibiting congruent motion (e.g., radial velocities), in a first image captured for a first scan cycle; calculating a confidence score of the first constellation of points representing a static surface in the environment surrounding the vehicle; and tracking the first constellation of points in a second image captured for a second scan cycle succeeding (or immediately after) the first scan cycle in response to the confidence score falling below a threshold score. Thus, the vehicle can track constellations of points in successive images to detect objects exhibiting motion consistent with a non-static surface, such as a second vehicle that momentarily exhibits zero radial velocity (e.g., momentarily appears as a static object) relative to the vehicle during the first scan cycle. In particular, in this variation, the vehicle can implement object tracking techniques: to link the first constellation of points—representing a particular object in the first image—to a similar constellation of points detected in the second image; and to link these constellations of points—and the objects they represent—across these two images.

In one example, for a first scan cycle, a first vehicle—traveling northbound toward an intersection of a roadway—accesses a first image annotated with positions and radial velocities of objects and surfaces proximal the intersection during the first scan cycle. In particular, the first vehicle accesses the first image generated by a radar sensor arranged on the first vehicle, the first image depicting surfaces in a forward-facing view of the radar sensor (and the vehicle more generally).

The first vehicle detects a first constellation of points in the first image representing a second vehicle—traveling eastbound through the intersection and arranged at a 0° rotational position relative to the first vehicle (e.g., directly in front of the first vehicle)—annotated with radial velocities of the second vehicle relative to the first vehicle. In particular, the first vehicle detects the first constellation of points annotated with low radial velocities relative to the first vehicle. More specifically, due to the position of the second vehicle (e.g., directly in front of the first vehicle) relative to the radar sensor arranged on the first vehicle, the radar sensor detects minimal lateral movement of the second vehicle. Thus, from the perspective of the radar sensor, the first constellation of points representing the second vehicle in the first image can momentarily (i.e., during the first scan cycle) appear as a static surface relative to the first vehicle.

The first vehicle then: identifies the first constellation of points as a possible static surface; and calculates a confidence score of the first constellation of points representing a static surface proximal the intersection. In particular, the first vehicle can implement artificial intelligence and computer vision techniques to classify objects represented in the image(s) based on geometry characteristics of objects derived from the image(s). In this example, the first vehicle can: implement artificial intelligence and computer vision techniques to classify the first constellation of points as a possible vehicle based on geometry characteristics of objects derived from the first image; and calculate a confidence score of 25% of the first constellation of points representing a static surface.

The first vehicle then initiates a second scan cycle to track the first constellation of points in response to the confidence score of 25% falling below a static surface threshold score of 90%. Then, for the second scan cycle, the vehicle: accesses a second image annotated with positions and radial velocities of surfaces proximal the intersection during the second scan cycle; and detects a second constellation of points in the second image representing the second vehicle traveling eastbound through the intersection and arranged at a 45° rotational position relative to the first vehicle. In particular, the first vehicle detects the second constellation of points annotated with radial velocities relative to the first vehicle that exceed radial velocities in the first image (i.e., indicating the second constellation of points represent a non-static surface). More specifically, due to the position of the second vehicle (e.g., angularly offset at a 45° angle) relative to the radar sensor arranged on the first vehicle, the radar sensor detects lateral movement of the second vehicle.

The first vehicle then: calculates a confidence score of 0% of the second constellation of points representing a static surface based on a difference between radial velocities of the first constellation of points and the second constellation of points; and mutes the second constellation of points in the second image in response to the confidence score of 0% falling below a minimum static surface threshold score. Thus, the vehicle can dynamically filter out non-static objects—such as moving vehicles or pedestrians—by tracking objects across successive scan cycles.

### 7.3 Variation: Non-Static Object Detection Based on Wheel Odometry

In one variation, as shown in FIG. 2, the vehicle can detect non-static objects by: calculating an estimated linear velocity of the vehicle during the scan cycle based on a wheel speed of a wheel of the vehicle during the scan cycle detected by a wheel speed sensor arranged on the vehicle in Block S144; accessing an image annotated with positions and radial velocities of a set of points relative to a radar sensor arranged on the vehicle in Block S120; for each point in the set of points, calculating a relative estimated radial velocity of the vehicle relative to the point based on the estimated linear velocity, and an azimuthal position of the point relative to the radar sensor; identifying a second constellation of points, in the first set of points, associated with first radial velocities congruent with motion of a singular object, deviating from corresponding relative estimated radial velocities of the vehicle during the scan cycle in Block S126; and identifying the second constellation of points as a non-static surface in Block S128. In this variation, in Block S128, the vehicle can discard the first constellation of points from calculation of the change in position.

Furthermore, in this variation, in Block S124, the vehicle can: detect a second constellation of points in the image annotated with the first radial velocity congruent with the estimated radial velocity of the vehicle during the scan cycle; and identify the second constellation of points, in the set of points, associated with radial velocities congruent with corresponding relative estimated radial velocities of the vehicle during the first scan cycle in Block S124. Thus, the vehicle can dynamically filter out non-static objects—such as moving vehicles or pedestrians—by leveraging differences in radial velocities between constellations of points in the image and an estimated radial velocity calculated for the vehicle during the scan cycle.

Accordingly, the vehicle can filter out non-static objects in each image based on: differences between radial velocities of a constellation of points relative to adjacent points and/or an estimated radial velocity calculated for the vehicle; and/or differences between radial velocities of a constellation of points across multiple, successive scan cycles. Therefore, the vehicle can increase accuracy in position calculations by reducing or eliminating noise (i.e., non-static objects) from the image: to enable the vehicle to focus on reliable, stationary references for position calculations; and to prevent the misinterpretation of motion of dynamic objects as part of the movement of the vehicle and/or the position of static surfaces.

### 8. Change in Linear Velocity+Position

Blocks of the method S100 recite: detecting a constellation of points, in the set of points in an image, representing a static surface in the set of surfaces in Block S124; accessing an angular velocity of the vehicle during the scan cycle detected by a motion sensor arranged on the vehicle in Block S130; calculating a linear velocity of the vehicle relative to the static surface during the scan cycle based on radial velocities of the constellation of points in Block S140; and calculating a change in position of the vehicle during the scan cycle based on the linear velocity, the angular velocity, and a duration of the scan cycle in Block S150. Generally, in Block S150, the vehicle stores the motion of the static surface relative to the motion sensor—derived from radial velocities of corresponding points in the image—as the absolute motion of the vehicle during the scan cycle.

Generally, in Block S114, each point in the image contains a radial position (e.g., a yaw angle), a radial distance, an azimuthal position (e.g., a pitch angle), and a radial velocity (e.g., Doppler shift) in the field of view of the radar sensor—and therefore in a coordinate system of the radar sensor. The constellation of points—representing the static surface—are static, and their motion is therefore known and fully defined.

Accordingly, in one implementation, in Block S140, the vehicle derives a composite linear velocity of the radar sensor—in the coordinate system of the radar sensor—that resolves the radial velocity of the static surface at the radial distance, radial position, and azimuthal position of multiple points (e.g., many points or all points) of the static surface.

Furthermore, in this implementation, in Block S150, the vehicle can calculate the change in position of the vehicle during the scan cycle by integrating the linear velocity and the angular velocity over a duration of the scan cycle.

### 8.1 Lateral+Longitudinal Velocity Components

In one implementation, the vehicle can decompose the radial velocities of the constellation of points and the angular velocity of the vehicle into lateral and longitudinal components. In particular, in this implementation, in Block S140, for each point in the constellation of points, the vehicle can calculate a lateral component and a longitudinal component of the radial velocity associated with the point based on the azimuthal position of the point in the image. By decomposing the lateral and longitudinal components of the radial velocity, the vehicle can distinguish forward movement (longitudinal) from sideward movement (lateral), thereby enabling the vehicle to derive an accurate trajectory relative to the environment.

The vehicle can then detect an offset between the radar sensor and the motion sensor, such as a linear offset and/or an angular offset between the positions of each sensor. More specifically, the vehicle can detect the offset between the sensors to align measurements from both sensors (e.g., to ensure measurements are recorded in a single coordinate system), thereby reducing potential errors in position calculations.

The vehicle can then calculate a composite longitudinal velocity of a reference position on the vehicle (or more generally, the vehicle) relative to the static surface during the scan cycle based on: longitudinal components of radial velocities of the constellation of points; the angular velocity; and the offset between the radar sensor and the motion sensor. Furthermore, the vehicle can calculate a composite lateral velocity of a reference position on the vehicle relative to the static surface based on: lateral components of radial velocities of the constellation of points; the angular velocity; and the offset between the radar sensor and the motion sensor. The vehicle can then calculate the change in linear velocity of the vehicle during the scan cycles based on the composite lateral velocity and the composite longitudinal velocity.

### 8.2 Lateral+Longitudinal Position Components

In another implementation, in Block S150, the vehicle can calculate the change in position of the vehicle during the scan cycle based on a change in longitudinal position, a change in lateral position, and a change in angular position of a reference position on the vehicle relative to the static surface during the scan cycle. In particular, the vehicle can: calculate the change in longitudinal position of a reference position on the vehicle relative to the static surface during the scan cycle based on the composite longitudinal velocity and the duration of the scan cycle; calculate the change in lateral position of a reference position on the vehicle relative to the static surface during the scan cycle based on the composite lateral velocity and the duration of the scan cycle; and calculate the change in angular position during the scan cycle based on the angular velocity and the duration of the scan cycle.

The vehicle can then fuse the change in longitudinal position, the change in lateral position, and the change in angular position to calculate the change in position of the vehicle relative to the static surface during the scan cycle. Thus, by decomposing the lateral and longitudinal position components, the vehicle can accurately derive forward movement (longitudinal) and sideward movement (lateral), thereby enabling the vehicle to derive an accurate change in position.

Accordingly, the vehicle can increase accuracy in the position calculation by: calculating both lateral and longitudinal components of velocity (i.e., of a static surface relative to the vehicle) to accurately calculate directionality; and fusing the lateral and longitudinal components of velocity with sensor offsets to correct for any discrepancies between sensor positions, thereby enabling the vehicle to account for angular and linear misalignments and thus reduce cumulative errors during extended GPS-denied navigation. Additionally or alternatively, the vehicle can implement an array of radar and sensors to derive the angular velocity by detecting shifts in relative positions of constellations of points in successive scans. By tracking constellations of points (i.e., detecting displacements of objects represented by constellations of points) via the array of radar sensors, the vehicle can derive angular velocity without reliance on IMUs.

Thus, rather than implementing IMUs (e.g., accelerometers) to calculate the position of the vehicle (e.g., based on acceleration data), the vehicle can integrate real-time radar images with the angular velocity of the vehicle to calculate position. By reducing reliance on IMUs, the vehicle can mitigate cumulative errors (i.e., drift) associated with calculating position from acceleration data detected by an IMU. Therefore, the vehicle can implement the aforementioned methods and techniques to increase accuracy and reliability of positioning, such as during extended periods of GPS-denied navigation.

### 8.3 Change in Absolute Position

Block S154 of the method S100 recites calculating an absolute position of the vehicle proximal an end time of the scan cycle based on: an initial absolute position of the vehicle proximal a start time of the scan cycle; and the change in position of the vehicle during the scan cycle.

In one implementation, for a first scan cycle, the vehicle can: implement methods and techniques described above to calculate a first change in position of the vehicle during the first scan cycle in Block S150; access an initial absolute position of the vehicle proximal the start time of the first scan cycle; and calculate an absolute position of the vehicle proximal an end time of the scan cycle based on the change in position of the vehicle during the first scan cycle originating from the initial absolute position in Block S154. The vehicle can repeat the foregoing process while the vehicle is in motion to recalculate the absolute geospatial position of the vehicle following each successive scan cycle. Therefore, the vehicle can continuously recalculate the absolute position, thereby enabling real-time navigation to maintain accurate positional awareness while navigating through the environment surrounding the vehicle.

### 8.4 Variation: Front-Facing+Side-Facing Radar Sensors

In one variation, the vehicle can access multiple images recorded by different radar sensors to derive the lateral and longitudinal velocity and position components, such as forward-facing sensors, rearward-facing sensors, and/or side-facing sensors. In particular, in this variation, for a scan cycle, the vehicle can: trigger a first radar sensor (e.g., via the controller) to capture a first image depicting a first field of view relative to the vehicle (e.g., a forward-facing view); and trigger a second radar sensor to capture a second image depicting a second field of view relative to the vehicle (e.g., a side-facing view). The vehicle can then implement methods and techniques described above to decompose the lateral and longitudinal position components of radial velocities of different sets of points in the images to derive the change in position of the vehicle during the scan cycle.

In one example, for a scan cycle, the vehicle can: access a first image generated by a forward-facing sensor (i.e., a radar sensor) arranged on the vehicle, the first image including a first set of points in a first field of view of the forward-facing sensor; and access a second image generated by a side-facing sensor (i.e., a radar sensor) arranged on the vehicle, the second image including a second set of points in a second field of view of the side-facing sensor.

The vehicle can then implement methods and techniques described above: to detect a first static surface represented by a first constellation of points in the first image; to detect a second static surface represented by a second constellation of points in the second image; and to calculate the change in linear velocity of the vehicle during the scan cycle based on the composite lateral velocity and the composite longitudinal velocity of the first and second constellations of points. In particular, in this example, the vehicle can: calculate a composite longitudinal velocity of a reference position on the vehicle (or more generally, the vehicle) relative to the first static surface during the scan cycle based on longitudinal components of radial velocities of the first constellation of points (i.e., detected by the forward-facing sensor); and calculate a composite lateral velocity of a reference position on the vehicle relative to the static surface based on lateral components of radial velocities of the second constellation of points (i.e., detected by the side-facing sensor).

The vehicle can then implement methods and techniques described above to calculate the change in position of the vehicle during the scan cycle based on: a change in longitudinal position of a reference position on the vehicle relative to the first static surface (i.e., detected by the forward-facing sensor and derived from the composite longitudinal velocity); and a change in lateral position of a reference position on the vehicle relative to the second static surface (i.e., detected by the side-facing sensor and derived from the composite lateral velocity). Accordingly, the vehicle can access multiple images captured by different radar sensors that depict various fields of view relative to the vehicle. Thus, the vehicle can leverage multiple radar sensors (i.e., capturing multiple reference points) to increase accuracy in the position calculation.

### 9. Obstructed Field of View

In one variation, in response to detecting an obstructed field of view of a first radar sensor (e.g., a forward-facing sensor), the vehicle can access images recorded by a second radar sensor (e.g., a side-facing sensor) oriented to capture a second field of view, different from the first field of view. For example, the vehicle can access images recorded by the second radar sensor in response to: failing to detect a constellation of points in the first image representing a static surface; and/or detecting a physical obstruction blocking the field of view of the first radar sensor.

In one example, for a scan cycle, the vehicle can: access a first image generated by a forward-facing sensor (i.e., a radar sensor) arranged on the vehicle, the first image including a first set of points in a first field of view of the forward-facing sensor; and, in response to failing to detect a constellation of points in the first image representing a static surface, access a second image generated by a side-facing sensor (i.e., a radar sensor) arranged on the vehicle, the second image including a second set of points in a second field of view of the side-facing sensor.

The vehicle can then implement methods and techniques described above: to detect a static surface represented by a constellation of points in the second image; to calculate the change in linear velocity of the vehicle during the scan cycle based on the composite lateral velocity and the composite longitudinal velocity of the constellation of points (i.e., detected by the side-facing sensor); and to calculate the change in position of the vehicle during the scan cycle based on a change in longitudinal position and a change in lateral position of a reference position on the vehicle relative to the static surface.

Accordingly, the vehicle can access multiple images captured by different radar sensors that depict various fields of view relative to the vehicle, such as when a radar sensor is obstructed or fails to detect static surfaces for calculating position changes. Thus, the vehicle can leverage multiple radar sensors (i.e., capturing multiple reference points) to maintain reliability of position calculations in the event of a compromised radar sensor.

### 10. Selective Signal Transmission

Block S190 of the method S100 recites generating the image depicting the set of surfaces in the field of view of the radar sensor. Generally, a radar sensor can generate an image by: transmitting signals (e.g., radio frequency signals) in a field of view of the radar sensor; measuring returned signals (e.g., measuring point clouds representing positions and strengths of returned signals) in the field of view of the radar sensor; and generating the image representing relative positions of a set of surfaces in the field of view of the radar sensor and annotated with radial velocities of the set of surfaces. More specifically, in Block S190, the vehicle can interpret the varying strengths of the returned signals to generate the image representing relative positions of the set of surfaces.

In one implementation, the vehicle can: calculate a first region (e.g., an active region) of a field of view of the radar sensor; and control the radar sensor to selectively scan (e.g., transmit signals within) the first region of the field of view of the radar sensor. In this implementation, the vehicle can control the radar sensor to selectively transmit signals and capture returned signals for the first region of the field of view of the radar sensor.

Additionally or alternatively, the vehicle can: calculate a second region (e.g., an inactive region) of a field of view of the radar sensor; and control the radar sensor to selectively disable the radar sensor for the second region of the field of view of the radar sensor. In this implementation, the vehicle can control the radar sensor to disable signal transmission by the radar sensor within the second region of the field of view of the radar sensor.

In one example, the vehicle: calculates a first region (e.g., 270°) of a 360° field of view of the radar sensor; and controls the radar sensor to selectively scan this first region via the radar sensor. More specifically, the vehicle controls the radar sensor to transmit signals (e.g., via a set of emitters) and to capture returned signals (e.g., via a set of antennas) within the first region of the 360° field of view of the radar sensor. In this example, the vehicle selectively disables signal transmission, by the radar sensor, of a second region (e.g., 90°) of the 360° field of view of the radar sensor.

In another example, the vehicle controls the radar sensor: to transmit signals at a first intensity (e.g., full intensity) for the first region of the 360° field of view of the radar sensor; and to transmit signals at a second intensity (e.g., partial intensity) falling below the first intensity for the second region of the 360° field of view of the radar sensor.

Accordingly, by selectively transmitting signals the active region of the field of view—while selectively disabling signal transmission within the inactive region of the field of view—the vehicle can: increase resolution of the image by consolidating bandwidth (e.g., points per second) of the radar sensor to the active region of the field of view; and/or reduce power consumption of the radar sensor.

### 11. Signal Transmission Characteristics

In one implementation, the vehicle can independently control characteristics of signal transmission by the radar sensor (e.g., a phased-array radar) for each region of the field of view of the radar sensor, such as by: controlling an azimuthal position of energy projection from the radar sensor for the region; and/or controlling an intensity of energy projection from the radar sensor for the region.

For example, the vehicle can: calculate a first signal transmission depth (e.g., 100% depth, 75% depth) for a first region of the field of view of the radar sensor; calculate a second signal transmission depth (e.g., 50% depth, 25% depth) for a second region of the field of view of the radar sensor; project energy from the radar sensor according to the first signal transmission depth for the first region of the field of view of the radar sensor; and project energy from the radar sensor according to the second signal transmission depth for the second region of the field of view of the radar sensor. Thus, the vehicle enables simultaneous detection and monitoring of objects within multiple target zones, thereby enabling tracking of both distant threats and nearby obstacles (e.g., during combat or reconnaissance missions).

### 12. Electromagnetic Signature Obfuscation

Generally, the vehicle can: access an image depicting a target entity (e.g., another vehicle, a structure, an installation); identify a target region—divergent from the geospatial position of the target entity—of a field of view of the radar sensor based on the location information; and control the radar sensor to selectively scan the target region of the field of view of the radar sensor.

### 12.1 Target Entity Location

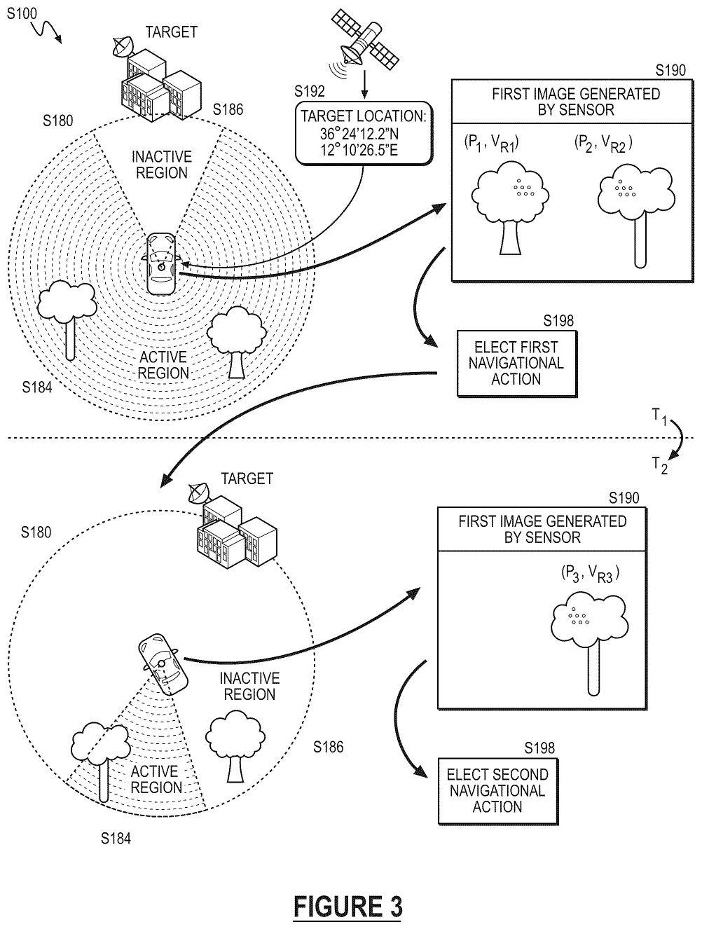

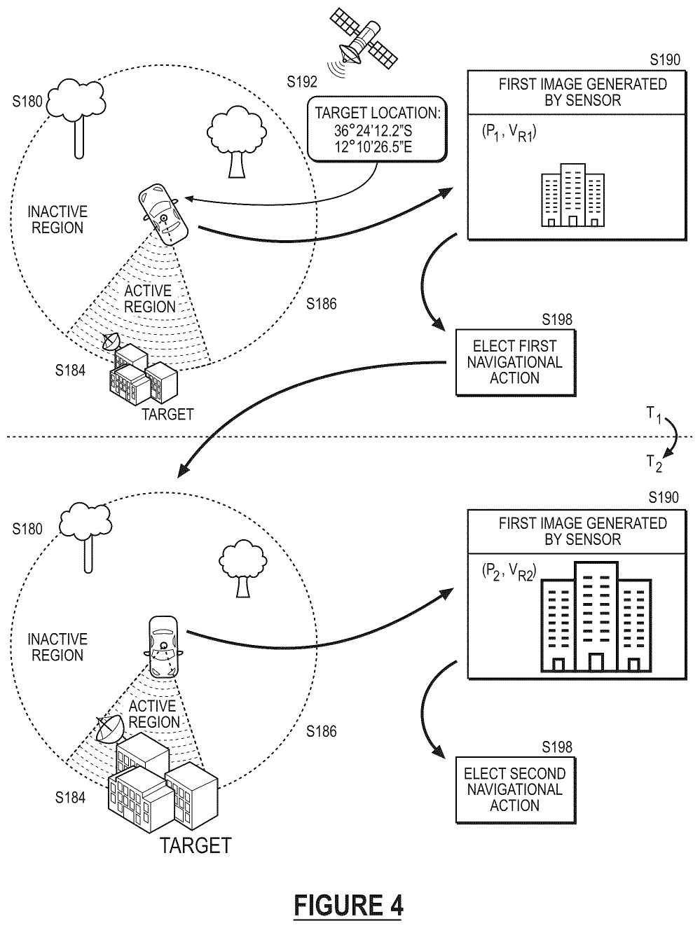

In one implementation, the vehicle can define a geospatial position of a target entity relative to the radar sensor or a reference position on the vehicle, such as an entity by which the vehicle avoids detection, as shown in FIGS. 3 and 4.

In one example, the vehicle accesses location information representing a geospatial position (e.g., geospatial coordinates) of a target vehicle.

In another example, the vehicle accesses location information representing a range of geospatial positions (e.g., a range of geospatial coordinates) defining boundaries of a region representing a target adversary defense installation.

In another example, the vehicle accesses an image including a constellation of points representing the target entity.

### 12.2 Selective Signal Transmission Based on Location Information

Blocks of the method S100 recite: accessing a geospatial position of a target entity in Block S192; prior to the first scan cycle, defining a first region of the field of view of the radar sensor divergent from the geospatial position of the target entity in Block S180; defining a second region of the field of view of the radar sensor coincident with the geospatial position of the target entity in Block S180;

in Block S180; during the scan cycle, triggering the radar sensor to selectively interrogate the first region of the field of view excluding the surface in Block S184; and during the scan cycle, triggering the radar sensor to selectively withhold interrogation of the second region of the field of view in Block S186.

In one implementation, as shown in FIG. 3, the vehicle can: derive a geospatial position of the target entity relative to the vehicle based on the constellation of points representing the target entity in the image; define a first region (e.g., an active region)—divergent from the geospatial position of the target entity—of a field of view of the radar sensor; and define a second region (e.g., an inactive region)—coincident with the geospatial position of the target entity in Blocks S180. The vehicle can then control the radar sensor to selectively transmit signals within the first region of the field of view of the radar sensor in Block S184.

For example, the vehicle can: access an image depicting a target entity; define the geospatial position of the target entity at a 0° rotational position relative to a radar sensor; and define an active region of a field of view of the radar sensor divergent from the position of the target entity, the active region of the field of view spanning from a 45° rotational position relative to the radar sensor to a 315° rotational position relative to the radar sensor. In this example, the vehicle can selectively transmit signals within the active region of the field of view of the radar sensor—divergent from the geospatial position, of the target entity, corresponding to the 0° rotational position relative to the radar sensor—spanning from the 45° rotational position to the 315° rotational position relative to the radar sensor.

Additionally or alternatively, the vehicle can: define an inactive region of the field of view of the radar sensor coincident the geospatial position of the target entity, the inactive region of the field of view spanning from the 315° rotational position relative to the radar sensor to the 45° rotational position relative to the radar sensor; and selectively disable (or reduce intensity/depth of) signal transmission by the radar sensor for the inactive region of the field of view.

Accordingly, the vehicle can constrain directions at which the radar sensor transmits signals to the active portion, of the field of view, diverging from a target entity by which the vehicle avoids detection. Therefore, the vehicle can: reduce an electromagnetic signature of the vehicle; and minimize a probability of detection by the target entity based on signal transmission by the radar sensor.

The vehicle can execute the foregoing methods and techniques for each radar sensor arranged on the vehicle: to independently define an active region—divergent from the geospatial position of the target entity—of a field of view of the radar sensor; and to selectively transmit signals within the active region of the field of view of the radar sensor.

Additionally or alternatively, the vehicle can execute the foregoing methods and techniques for each radar sensor arranged on the vehicle: to independently define an inactive region—coincident the geospatial position of the target entity—of a field of view of the radar sensor; and to selectively disable signal transmission within the inactive region of the field of view of the radar sensor.

### 12.3 Selective Signal Transmission Based on Object Characteristic

In one implementation, the vehicle can implement methods and techniques described in U.S. patent application Ser. No. 17/182,165: to access a first image—generated by a radar sensor arranged on the vehicle—including a set of points representing relative positions of a set of surfaces in a field of view of the radar sensor (e.g., an active region of a field of view divergent from a target entity) and annotated with radial velocities of the set of surfaces; to detect a constellation of points, exhibiting congruent motion (e.g., radial velocities), in the first image; and to identify this constellation of points as corresponding to an object in the environment surrounding the vehicle for the second scan cycle.

As described above, the vehicle can: track this constellation of points in a second image captured for a second scan cycle succeeding the first scan cycle; and, from radial velocities of points in these constellations in the first and second images, derive motion of the vehicle from the first scan cycle to the second scan cycle.

In another implementation, based on the motion of the motion of the vehicle, the vehicle can calculate an expected position of the object—relative to the vehicle—at the time of a third time scan cycle based on the second scan cycle. Then, the vehicle can implement methods and techniques described above: to define an active region—coincident the expected position of the object during the third scan cycle—of a field of view of the radar sensor; to selectively transmit signals within the active region of the field of view of the radar sensor during the third scan cycle; and to selectively disable (or reduce intensity/depth of) signal transmission by the radar sensor within an inactive region—divergent from the expected position of the object—of the field of view of the radar sensor. More specifically, the vehicle can define the active region coincident the expected position of the object during the third scan cycle and divergent from the geospatial position of the target entity.

For example, the vehicle can: detect a constellation of points, exhibiting congruent motion (e.g., radial velocities), in a second image captured for a second scan cycle; identify this constellation of points as corresponding to an object (e.g., a rock, a tree) at a 90° rotational position relative to the radar sensor during the second scan cycle; and, based on motion of the object (e.g., nil) and motion of the vehicle, calculate an expected position of the object—relative to the vehicle for a third scan cycle succeeding the second time—corresponding to a 105° rotational position relative to the radar sensor. In this example, the vehicle can: define an active region of a field of view of the radar sensor coincident the expected position of the object for the third scan cycle, the active region of the field of view spanning from a 90° rotational position relative to the radar sensor to a 130° rotational position relative to the radar sensor; and selectively transmit signals within the active region—spanning from the 90° rotational position to the 130° rotational position relative to the radar sensor—of the field of view of the radar sensor. Additionally, the vehicle can disable signal transmission, by the radar sensor, within an inactive region of the field of view spanning from the 130° rotational position to the 90° rotational position relative to the radar sensor.

Accordingly, the vehicle can: target a specific object to scan over successive scan cycles of the radar sensor; and further constrain directions at which the radar sensor transmits signals. Therefore, the vehicle can: capture motion data of the vehicle—based on images generated according to these scan cycles—for state determination of the vehicle while further reducing power consumption and minimizing an electromagnetic signature of the vehicle.

### 12.3.1 Object Selection

In one implementation, the vehicle can: define a first region—divergent from a geospatial position of a target entity—of a first field of view of a radar sensor; and control the radar sensor to selectively transmit signals within the first region of the first field of view of the radar sensor. The vehicle can: access a first image—generated by the radar sensor for the second scan cycle—including a first set of points representing relative positions of a first set of surfaces in the first region of the first field of view of the radar sensor; detect constellations of points, exhibiting congruent motion (e.g., radial velocities), in the first image; and identify each of these constellations of points as corresponding to an object, in a set of objects, in the environment surrounding the vehicle during the first scan cycle.

In another implementation, the vehicle can select an object, in the set of objects, for which to calculate an expected position for a second scan cycle succeeding the first scan cycle. More specifically, the vehicle can select the object based on energy reflection (or energy absorption) characteristics of the object.

In one example, the vehicle: accesses the first image annotated with intensities of returned signals of surfaces (or points); ranks the set of objects in order of intensity of returned signal (e.g., average intensity of returned signals for a constellation of points); and selects an object, in the set of objects, exhibiting least intensity of returned signal.

In another example, the vehicle: implements artificial intelligence and computer vision techniques to classify objects, in the set of objects, based on geometry characteristics of objects derived from an image; accesses a database defining signal absorption characteristics (or energy reflection characteristics) of classified objects; assigns a signal absorption characteristic to each object in the set of objects; ranks the set of objects based on energy signal characteristics; and selects an object, in the set of objects, exhibiting greatest signal absorption characteristic.

In these examples, the vehicle then implements methods and techniques described above: to calculate an expected position of the object relative to the vehicle for a second scan cycle succeeding the first scan cycle; to define an active region—coincident the expected position of the object and divergent from the geospatial position of the target entity—of a field of view of the radar sensor; and to selectively transmit signals within the active region of the field of view of the radar sensor during the second scan cycle.

Accordingly, by selecting an object exhibiting a greatest energy absorption characteristic (and/or least intensity of returned signal energy) and selectively transmitting signals within a region—coincident an expected position of the object—of the field of view of the radar sensor, the vehicle can minimize energy reflected from the object—which may be detectable by the target entity—responsive to a scan cycle of the radar sensor, thereby minimizing a probability of detection by the target entity.

In one variation, the vehicle can select a different object, in the set of objects, to scan for successive scan cycles. For example, for a third scan cycle succeeding the second scan cycle, the vehicle can: select a second object, in the set of objects, exhibiting a second greatest signal absorption characteristic; calculate a second expected position of the second object relative to the vehicle for the third scan cycle; define a second active region—coincident the second expected position of the second object and divergent from the geospatial position of the target entity—of a field of view of the radar sensor; and selectively scan the second active region of the field of view of the radar sensor during the third scan cycle.

Accordingly, by selecting different target objects to scan during successive scan cycles, the vehicle can reduce a likelihood that the target entity may derive a position of the vehicle based on transmitting signals to these target objects. Therefore, the vehicle can minimize a probability of detection by the target entity based on signal transmission by the radar sensor.

In another variation, the vehicle can select an object, in the set of objects, exhibiting a least signal absorption characteristic (and/or greatest intensity of returned signal energy). In this variation, the vehicle can: reduce an intensity of signal transmission by the radar sensor; and selectively transmit signals within a region—coincident an expected position of the object—of the field of view of the radar sensor.

### 12.4 Variation: Redefined Fields of View

Blocks of the method S100 recite: detecting a constellation of points, in the set of points in the image, representing a surface in the set of surfaces in Block S126; prior to the first scan cycle, defining a first region of the field of view of the radar sensor, excluding a second region of the field of view of the radar sensor intersecting the surface based on a position of the surface in the image in Block S180; during the scan cycle, triggering the radar sensor to selectively interrogate the first region of the field of view excluding the surface in Block S184; and, during the scan cycle, triggering the radar sensor to selectively withhold interrogation of the second region of the field of view in Block S186.

In one variation, the vehicle can redefine fields of view of the radar sensor in order to avoid re-interrogating a particular surface proximal the vehicle during multiple consecutive scan cycles. In this variation, the vehicle can: access an image generated by the radar sensor and including a first set of points representing positions of a set of surfaces in a first field of view of the radar sensor during a scan cycle; detect a first constellation of points, in the first set of points in the radar image, representing a surface in the set of surfaces; prior to a second scan cycle succeeding the first scan cycle, define a second field of view of the radar sensor excluding a region of the first field of view of the radar sensor intersecting the surface based on a position of the surface in the radar image; and, during the second scan cycle, trigger the radar sensor to selectively interrogate the first field of view excluding the surface. Therefore, the vehicle can target different objects to scan over successive scan cycles of the radar sensor and further constrain directions at which the radar sensor transmits signals.

### 13. Electromagnetic Signature Localization

Blocks of the method S100 recite: defining a first region of the field of view of the radar sensor, the first region coincident with the geospatial position of the target entity in Block S180; defining a second region of the field of view of the radar sensor, the second region divergent from the geospatial position of the target entity in Block S180; selectively transmitting signals via the radar sensor within the first region of the field of view of the radar sensor in Block S184; and selectively disabling signal transmission by the radar sensor for the second region of the field of view of the radar sensor in Block S186.

In one variation, as shown in FIG. 4, rather than calculating an active region—divergent from a geospatial position of a target entity—of a field of view of a radar sensor arranged on the vehicle, the vehicle can define the active region coincident the geospatial position of the target entity in Block S180.

For example, the vehicle can implement foregoing methods and techniques: to access location information representing a geospatial position of a target entity, such as an aircraft carrier on which the vehicle is to land or a convoy the vehicle is to follow; to define an active region—coincident the geospatial position of the target entity—of a field of view of the radar sensor; and to control the radar sensor to selectively transmit signals within the active region of the field of view of the radar sensor. In this example, the vehicle can disable signal transmission by the radar sensor within an inactive region—divergent from the geospatial position of the target entity—of the field of view of the radar sensor.

Accordingly, the vehicle can constrain signal transmission by the radar sensor to the active region of the field of view, of the radar sensor, coincident a target entity by which the vehicle seeks detection. Therefore, the vehicle can localize an electromagnetic signature of the vehicle detectable by the target entity while minimizing a probability of detection—by other entities by which the vehicle avoids detection—based on signal transmission by the radar sensor.

### 13.1 Signaling

Generally, the vehicle can: generate a signal representing a message from the vehicle to the target entity, such as a signal representing task information and/or status information associated with the vehicle; and control the radar sensor to transmit the signal during a scan cycle(s).

In one example, the vehicle generates the signal representing: a current trajectory of the vehicle; a current operating status (e.g., nominal, fault, safe) of the vehicle; a set of queued autonomous actions to be executed by the vehicle; presence of the vehicle; identification information of the vehicle; and/or other information associated with the vehicle.

In another example, the vehicle generates the signal representing: a change in vehicular speed (e.g., acceleration, deceleration) after a first scan cycle; a change in steering azimuthal position after a second scan cycle; a change in the set of queued autonomous actions; and/or a change in operating status of the vehicle.

In another implementation, the vehicle can generate the signal representing a request for information from another vehicle (or non-vehicle system). For example, the vehicle can generate the signal representing: a request for motion information associated with a second vehicle; a request for objects—detected by the second vehicle—that may be obscured by the second vehicle and undetected by the vehicle; and/or a request for motion data associated with these objects.

In yet another implementation, the vehicle can generate the signal representing a response to a received request for information from another vehicle (or non-vehicle system). For example, the vehicle can generate the signal representing: a set of objects detected by the vehicle; and derived motion data associated with these objects. The vehicle can then control the radar sensor to transmit the signal during a scan cycle.

### 14. Variation: Lidar Sensors

In one variation, the vehicle can additionally or alternatively include a set of (i.e., one or more 360°) light detection and ranging (hereinafter “lidar”) sensors configured to project structured light into the environment surrounding the vehicle. More specifically, for each scan cycle (e.g., one revolution), the lidar sensor(s) are configured to generate an image by: illuminating a field of view of the lidar sensor; measuring returned energy in the field of view of the lidar sensor; and generating the image representing relative positions of a set of surfaces in the field of view of the lidar sensor and annotated with radial velocities of the set of surfaces.

In this variation, the vehicle can implement foregoing methods and techniques: to access location information representing a geospatial position of a target entity; to define an active region—coincident the geospatial position of the target entity (or divergent from the geospatial position of the target entity)—of a field of view of the lidar sensor; to define an inactive region—divergent from the geospatial position of the target entity (or coincident the geospatial position of the target entity)—of a field of view of the lidar sensor; to control a lidar sensor to selectively illuminate the active region of the field of view of the lidar sensor; and to selectively disable illumination by the lidar sensor within an inactive region—divergent from the geospatial position of the target entity—of the field of view of the lidar sensor.

In another variation, the vehicle can additionally or alternatively include: a set of infrared emitters configured to project structured light into the environment surrounding the vehicle; a set of infrared detectors (e.g., infrared cameras); and a processor configured to transform images output by the infrared detector(s) into an image of the environment.

In another variation, the vehicle can additionally or alternatively include a set of color cameras facing outwardly from the front, rear, and/or sides of the vehicle. For example, each camera in this set can output a video feed of digital photographic images at a rate of 20 Hz.

The controller in the vehicle can thus fuse data streams from the radar sensor(s), the lidar sensor(s) and/or the color camera(s) into one image—such as in the form of a three-dimensional color map, three-dimensional point cloud, or a four-dimensional point cloud containing constellations of points that represent roads, sidewalks, vehicles, pedestrians, etc. in the environment surrounding the vehicle—per scan cycle.

### 15. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a first radar image generated by a first radar sensor arranged on a vehicle, the first radar image comprising a first set of points:
representing positions of a first set of surfaces in a first field of view of the first radar sensor during a first scan cycle; and
annotated with radial velocities of the first set of surfaces relative to the first radar sensor;
detecting a first constellation of points, in the first set of points in the first radar image, representing a first static surface in the first set of surfaces;
calculating a first linear velocity of the vehicle relative to the first static surface during the first scan cycle based on radial velocities of the first constellation of points;
accessing a first angular velocity of the vehicle detected by a motion sensor, arranged on the vehicle, during the first scan cycle; and
calculating a first change in position of the vehicle during the first scan cycle based on:
the first linear velocity;
the first angular velocity; and
a first duration of the first scan cycle.

2. The method of claim 1:
further comprising:
accessing a second radar image generated by the first radar sensor and comprising a second set of points:
representing positions of a second set of surfaces in a second field of view of the first radar sensor during a second scan cycle preceding the first scan cycle;
detecting a second constellation of points, in the second set of points in the second radar image, representing a second surface in the second set of surfaces;
prior to the first scan cycle, defining the first field of view of the first radar sensor:
excluding a region of the second field of view of the first radar sensor intersecting the second surface based on a position of the second surface in the second radar image; and
during the first scan cycle, triggering the first radar sensor to selectively interrogate the first field of view excluding the second surface; and
wherein accessing the first radar image comprises accessing the first radar image comprising the first set of points representing the first set of surfaces, excluding the second surface, in the first field of view.

3. The method of claim 1, further comprising:
correlating a second constellation of points, in the first set of points, with a second vehicle in the first field of view of the first radar sensor;
during a second scan cycle succeeding the first scan cycle:
in response to detecting the second vehicle, represented by the second constellation of points, in the first field of view of the first radar sensor:
deactivating the first radar sensor; and
accessing a second radar image generated by a second radar sensor arranged on the vehicle and defining a second field of view different from the first field of view, the second radar image comprising a second set of points:
representing positions of a second set of surfaces in the second field of view of the second radar sensor during the second scan cycle; and
annotated with radial velocities of the second set of surfaces relative to the second radar sensor;
detecting a third constellation of points, in the second set of points in the second radar image, representing a second static surface in the second set of surfaces;
calculating a second linear velocity of the vehicle relative to the second static surface during the second scan cycle based on radial velocities of the third constellation of points;
accessing a second angular velocity of the vehicle detected by the motion sensor during the second scan cycle; and
calculating a second change in position of the vehicle during the second scan cycle based on:
the second linear velocity;
the second angular velocity; and
a second duration of the second scan cycle.

4. The method of claim 1:
wherein calculating the first linear velocity of the vehicle relative to the first static surface during the first scan cycle comprises:
for each point in the first constellation of points, calculating a longitudinal component of a radial velocity associated with the point based on an azimuthal position of the point in the first radar image; and
calculating a first composite longitudinal velocity of a reference position on the vehicle relative to the first static surface based on:
longitudinal components of radial velocities of the first constellation of points;
the first angular velocity; and
an offset between the first radar sensor and the reference position on the vehicle; and
wherein calculating the first change in position of the vehicle during the first scan cycle comprises calculating a first change in longitudinal position of the reference position on the vehicle relative to the first static surface during the first scan cycle based on:
the first composite longitudinal velocity; and
the first duration of the first scan cycle.

5. The method of claim 4:
wherein accessing the first radar image comprises accessing the first radar image generated by the first radar sensor comprising a forward-facing radar sensor arranged on the vehicle;
further comprising, for the first scan cycle:
accessing a second radar image generated by a side-facing radar sensor arranged on the vehicle, the second radar image comprising a second set of points:
representing positions of a second set of surfaces in a second field of view of the side-facing radar sensor; and
annotated with radial velocities of the second set of surfaces relative to the side-facing radar sensor; and
detecting a second constellation of points, in the second set of points in the second radar image, representing a second static surface in the second set of surfaces;
wherein calculating the first linear velocity of the vehicle relative to the first static surface during the first scan cycle further comprises:
for each point in the second constellation of points, calculating a lateral component of the radial velocity associated with the point based on an azimuthal position of the point in the second radar image; and
calculating a second composite lateral velocity of the reference position on the vehicle relative to the second static surface based on:
lateral components of radial velocities of the second constellation of points;
the first angular velocity; and
a second offset between the side-facing radar sensor and the reference position on the vehicle; and
wherein calculating the first change in position of the vehicle during the first scan cycle comprises:
calculating a first change in lateral position of the reference position on the vehicle relative to the second static surface during the first scan cycle based on:
the second composite lateral velocity; and
the first duration of the first scan cycle;
calculating a first change in angular position of the reference position on the vehicle during the first scan cycle based on:
the first angular velocity; and
the first duration of the first scan cycle; and
calculating the first change in position based on:
the first change in longitudinal position;
the first change in lateral position; and
the first change in angular position.

6. The method of claim 4:
wherein calculating the first linear velocity of the vehicle relative to the first static surface during the first scan cycle further comprises:
for each point in the first constellation of points, calculating a lateral component of the radial velocity associated with the point based on the azimuthal position of the point in the first radar image; and
calculating a first composite lateral velocity of the reference position on the vehicle relative to the first static surface based on:
lateral components of radial velocities of the first constellation of points;
the first angular velocity; and
the offset between the first radar sensor and the reference position on the vehicle; and
wherein calculating the first change in position of the vehicle during the first scan cycle comprises:
calculating a first change in lateral position of the reference position on the vehicle relative to the first static surface during the first scan cycle based on:
the first composite lateral velocity; and
the first duration of the first scan cycle;
calculating a first change in angular position of the reference position on the vehicle relative to the first static surface during the first scan cycle based on:
the first angular velocity; and
the first duration of the first scan cycle; and
calculating the first change in position based on:
the first change in longitudinal position;
the first change in lateral position; and
the first change in angular position.

7. The method of claim 1:
wherein calculating the first change in position of the vehicle during the first scan cycle comprises integrating the first linear velocity and the first angular velocity over the first duration of the first scan cycle; and
further comprising calculating a first absolute position of the vehicle proximal an end time of the first scan cycle based on:
an initial absolute position of the vehicle proximal a start time of the first scan cycle; and
the first change in position.

8. The method of claim 7, further comprising:
accessing a second radar image generated by the first radar sensor and comprising a second set of points:
representing positions of a second set of surfaces in a second field of view of the first radar sensor during a second scan cycle succeeding the first scan cycle; and
annotated with radial velocities of the second set of surfaces relative to the first radar sensor;
detecting a second constellation of points, in the second set of points in the second radar image, representing a second static surface in the second set of surfaces;
calculating a second linear velocity of the vehicle relative to the second static surface during the second scan cycle based on radial velocities of the second constellation of points;
accessing a second angular velocity of the vehicle detected by the motion sensor during the second scan cycle;
calculating a second change in position of the vehicle during the second scan cycle based on:
the second linear velocity;
the second angular velocity; and
a second duration of the second scan cycle; and
calculating a second absolute position of the vehicle proximal a second end time of the second scan cycle based on:
the first absolute position of the vehicle proximal the end time of the first scan cycle; and
the second change in position.

9. The method of claim 1, wherein detecting the first constellation of points, in the first set of points in the first radar image, representing the first static surface in the first set of surfaces comprises:
detecting the first constellation of points annotated with radial velocities congruent with motion of a first common surface;
detecting a second constellation of points annotated with radial velocities congruent with motion of a second common surface;
accessing a first velocity estimate of the vehicle;
identifying the first constellation of points as representing the first static surface in response to congruence between radial velocities of the first constellation of points and the first velocity estimate of the vehicle; and
muting the second constellation of points in the first radar image in response to deviation of radial velocities of the first constellation of points from the first velocity estimate of the vehicle.

10. The method of claim 1, further comprising:
accessing a second radar image generated by the first radar sensor comprising a forward-facing radar sensor, the second radar image comprising a second set of points:
representing positions of a second set of surfaces in the first field of view of the forward-facing radar sensor during a second scan cycle, succeeding the first scan cycle; and
annotated with radial velocities of the second set of surfaces relative to the first radar sensor; and
in response to failing to detect a second constellation of points in the second radar image representing a second static surface:
accessing a third radar image generated by a side-facing radar sensor arranged on the vehicle, the third radar image comprising a third set of points:
representing positions of a third set of surfaces in a second field of view of the side-facing radar sensor during the second scan cycle; and
annotated with radial velocities of the third set of surfaces relative to the side-facing radar sensor;
detecting a third constellation of points, in the third set of points in the third radar image, corresponding to a third static surface in the third set of surfaces;
calculating a second linear velocity of the vehicle relative to the third static surface during the second scan cycle based on radial velocities of the third constellation of points;
accessing a second angular velocity of the vehicle during the second scan cycle detected by the motion sensor; and
calculating a second change in position of the vehicle during the second scan cycle based on:
the second linear velocity;
the second angular velocity; and
a second duration of the second scan cycle.

11. The method of claim 1, further comprising initiating the first scan cycle in response to loss of access to a geospatial positioning system.

12. The method of claim 1:
further comprising calculating an estimated linear velocity of the vehicle during the first scan cycle based on a wheel speed of a wheel of the vehicle detected by a wheel speed sensor arranged on the vehicle; and
wherein detecting the first constellation of points in the first radar image corresponding to the first static surface comprises:
for each point in the first set of points:
calculating a relative estimated radial velocity of the vehicle relative to the point based on:
the estimated linear velocity; and
an azimuthal position of the point relative to the first radar sensor; and
identifying the first constellation of points, in the first set of points, associated with first radial velocities congruent with corresponding relative estimated radial velocities of the vehicle during the first scan cycle.

13. The method of claim 12, further comprising:
identifying a second constellation of points, in the first set of points, associated with first radial velocities:
congruent with motion of a singular object; and
deviating from corresponding relative estimated radial velocities of the vehicle during the first scan cycle;
identifying the second constellation of points as a non-static surface; and
discarding the second constellation of points from calculation of the first change in position.

14. A method comprising:
accessing a first image generated by a first electromagnetic sensor arranged on a vehicle, the first image comprising a first set of points:
representing positions of a first set of surfaces in a first field of view of the first electromagnetic sensor during a first scan cycle; and
annotated with radial velocities of the first set of surfaces relative to the first electromagnetic sensor;
detecting a first constellation of points, in the first set of points in the first image, representing a first static surface in the first set of surfaces;
calculating a first linear velocity of the vehicle relative to the first static surface during the first scan cycle based on radial velocities of the first constellation of points;
accessing a first angular velocity of the vehicle during the first scan cycle detected by a motion sensor arranged on the vehicle; and
calculating a first change in position of the vehicle during the first scan cycle based on:
the first linear velocity;
the first angular velocity; and
a first duration of the first scan cycle.

15. The method of claim 14, wherein accessing the first image comprises accessing the first image depicting the first set of surfaces in the first field of view of the first electromagnetic sensor comprising a radar sensor.

16. The method of claim 14, wherein accessing the first image comprises accessing the first image depicting the first set of surfaces in the first field of view of the first electromagnetic sensor comprising a lidar sensor.

17. The method of claim 14:
further comprising:
accessing a second image generated by the first electromagnetic sensor and comprising a second set of points:
representing positions of a second set of surfaces in a second field of view of the first electromagnetic sensor during a second scan cycle preceding the first scan cycle;
detecting a second constellation of points, in the second set of points in the second image, representing a second surface in the second set of surfaces; and
prior to the first scan cycle, defining the first field of view of the first electromagnetic sensor:
excluding a region of the second field of view of the first electromagnetic sensor intersecting the second surface based on a position of the second surface in the second image; and
during the first scan cycle, triggering the first electromagnetic sensor to selectively interrogate the first field of view excluding the second surface; and
wherein accessing the first image comprises accessing the first image comprising the first set of points representing the first set of surfaces, excluding the second surface, in the first field of view.

18. The method of claim 14, further comprising:
correlating a second constellation of points, in the first set of points, with a second vehicle in the first field of view of the first electromagnetic sensor;
during a second scan cycle succeeding the first scan cycle:
in response to detecting the second vehicle, represented by the second constellation of points, in the first field of view of the first electromagnetic sensor:
deactivating the first electromagnetic sensor; and
accessing a second image generated by a second electromagnetic sensor arranged on the vehicle and defining a second field of view different from the first field of view, the second image comprising a second set of points:
representing positions of a second set of surfaces in the second field of view of the second electromagnetic sensor during the second scan cycle; and
annotated with radial velocities of the second set of surfaces relative to the second electromagnetic sensor;
detecting a third constellation of points, in the second set of points in the second image, representing a second static surface in the second set of surfaces;
calculating a second linear velocity of the vehicle relative to the second static surface during the second scan cycle based on radial velocities of the third constellation of points;
accessing a second angular velocity of the vehicle detected by the motion sensor during the second scan cycle; and
calculating a second change in position of the vehicle during the second scan cycle based on:
the second linear velocity;
the second angular velocity; and
a second duration of the second scan cycle.

19. The method of claim 14, further comprising initiating the first scan cycle in response to loss of access to a geospatial positioning system.

20. A method comprising:
accessing an image generated by an electromagnetic sensor arranged on an object, the image comprising a set of points:
representing positions of a set of surfaces in a field of view of the electromagnetic sensor during a scan cycle; and
annotated with radial velocities of the set of surfaces relative to the electromagnetic sensor;
detecting a constellation of points, in the set of points in the image, representing a static surface in the set of surfaces;
calculating a linear velocity of the object relative to the static surface during the scan cycle based on radial velocities of the constellation of points;
accessing an angular velocity of the object during the scan cycle; and
calculating a change in position of the object during the scan cycle based on:
the linear velocity;
the angular velocity; and
a duration of the scan cycle.
